(19) United States
(12) Patent Application Publication
(10) Pub. No.: US 2008/0249890 A1
(43) Pub. Date: Oct. 9, 2008

(54) ANONYMOUS ONLINE MATCHING FOR PRODUCTS AND SERVICES

(75) Inventors: Chris Sower, Holladay, UT (US); David Cumming, Park City, UT (US)

Correspondence Address: WORKMAN NYDEGGER, 60 EAST SOUTH TEMPLE, 1000 EAGLE GATE TOWER, SALT LAKE CITY, UT, 84111, US

(73) Assignee: SINGLEEDGE DEVELOPMENT, INC., Salt Lake City, UT (US)

(21) Appl. No.: 12/098,366

(22) Filed: Apr. 4, 2008

Related U.S. Application Data
(60) Provisional application No. 60/910,386, filed on Apr. 5, 2007.

(51) Int. Cl. G06Q 30/00

(52) U.S. Cl. 705/26

(57) ABSTRACT

The present invention extends to methods, systems, and computer program products for anonymous online matching for products and services. A listing party uploads a detailed profile (e.g., indicating goods and/or service they desire to purchase) to a matching system. The matching system, automatically and/or manually, detects a match with a potential seller. The matching system sends a redacted profile to the potential seller. The redacted profile includes product and/or service information but omits indentify information of the listing party. The seller determines if further investigation is worthwhile (e.g., purchase of the detailed profile including identify information) based on the content of the redacted profile.

### CROSS-REFERENCE TO RELATED APPLICATIONS

This application claims the benefit of U.S. Provisional Patent Application No. 60/910,386, entitled “Anonymous Online Matching For Products And Services”, filed on Apr. 5, 2007, which is incorporated herein in its entirety.

### BACKGROUND

### Background and Relevant Art

A significant aspect of all economic exchanges is the transaction costs. These include (a) the cost of searching for a desired good or service (or, on the other side, a customer) (b) the cost of acquiring information (c) the cost of bargaining and (d) the cost of enforcement.

With some items (e.g., a package of potato chips), transaction costs are minimal, involving only the time necessary to locate the chips in a convenience store and the time waiting in line at the cashier.

For other items (e.g. antiques, such as, an 18th century silver teapot made by Hester Bateman) the transaction costs can be very high. As an example: A buyer in Portland, Oreg. may wish to buy the teapot. A seller in Tyler, Tex. may own one and wish to sell it. However, the costs of either buyer or seller finding the other are so large as to make the transaction extremely unlikely. These types of high transaction costs have spawned a number of commercial enterprises whose function is to locate, purchase and resell particular classes of items to retailers where a buyer would be able to find them. For the teapot example, this would involve purchase by a “runner” who located the good and a resale through one or more intermediaries to stores in New York or London that are known to carry this kind of item.

Transaction costs were historically quite different for purchases of complex services like construction projects. These kinds of complex services require greater analysis and information gathering and are not easily transferred from one geographic location to another. Typically exchanges begin with a request for proposals (RFP). This contains considerable information and maps a process for gaining more information. It is sent to likely sellers and is frequently published.

Further, the sale of goods and simple services has been dramatically changed by the advent of the Internet. For instance, the seller of a teapot can likely find a buyer by means of online auction Web sites. Likewise, if you want someone to walk your dog, you can likely find someone with a Web based search engine.

At least two aspects of online auction sites make them especially useful. First, the solicitation is for bids and that acts as a filter; there is no effective way for a buyer to engage the seller other than by making a bid in an automated system. That relieves a seller of the transaction burden of sifting through a very large number of responses. Second, feedback scores for participants give an unusually reliable index of the reliability of counterparties.

However, the Internet has not, thus far, significantly changed the transaction costs typically associated with more complex services, such as, for example, RFP process. Thus, where the good or service desired is complex, transaction costs of information gathering and analysis are still often likely to be high. Transaction costs in these situations can be minimized to some extent by having a purchaser describe with particularity what is desired as well as the purchaser's qualifications for an exchange. Sellers can then triage requests, determining which they are best suited to perform, which have the best profit margins and which they are likeliest to be awarded. By selecting, the seller can maximize return on the unavoidable investment represented by transaction costs.

The Internet has replicated some aspects of the RFP model. For instance, individuals looking for romantic attachment can find Web sites where they can describe the person they are seeking. Similarly, Employers can find Web sites where they can describe the qualifications of an employee that they wish to hire.

Unfortunately, these existing models lack at least one important aspect of the seller initiated Internet models. On many online auction Web sites, the seller incurs minimal charges for a listing and pays larger, but still small, charges upon an exchange taking place. However, the intended audience for the listing incurs no charge whatever for a search through the listing, and any other number (however large) of listings of available products. By contrast, employment and romantic sites impose essentially all of the costs prior to the search on one party or the other, or both.

### BRIEF SUMMARY

The present invention extends to methods, systems, and computer program products for anonymous online matching for products and services. A listing party uploads a detailed profile (e.g., indicating goods and/or service they desire to purchase) to a matching system. The matching system receives the detailed profile from a listing party and stores the detailed. The listing party indicates to the matching system the number of actions the listing party is willing to receive for the detailed profile.

The matching system, automatically and/or manually, detects a match with a potential seller. The seller requests a profile for the listing party. The matching system receives the request and sends a redacted profile to the potential seller. The redacted profile includes product and/or service information but omits indentify information. The seller determines if further investigation is worthwhile based on the content of the redacted profile. For example, if the seller can provider the goods and/or services that are desired.

When further investigation is appropriate, the seller purchasing the detailed profile from the matching system. The matching system sends the detailed profile to the seller. The seller uses identity information in the detailed profile to contact the listing party.

In some embodiments, matching is performed between students and as prospective educational institutions.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates anonymous online matching for products and services.

FIG. 2 illustrates another example computer architecture that facilitates anonymous online matching between students and prospective education institutions.

FIGS. 3A and 3B illustrate a flow chart of an example method for anonymous online matching for products and services.

### DETAILED DESCRIPTION

The present invention extends to systems, methods, and computer program products for anonymous online matching for products and services. A listing party uploads a detailed profile (e.g., indicating goods and/or service they desire to purchase) to a matching system. The matching system receives the detailed profile from a listing party and stores the detailed. The listing party indicates to the matching system the number of actions the listing party is willing to receive for the detailed profile.

The matching system, automatically and/or manually, detects a match with a potential seller. The seller requests a profile for the listing party. The matching system receives the request and sends a redacted profile to the potential seller. The redacted profile includes product and/or service information but omits indentify information. The seller determines if further investigation is worthwhile based on the content of the redacted profile. For example, if the seller can provider the goods and/or services that are desired.

When further investigation is appropriate, the seller purchasing the detailed profile from the matching system. The matching system sends the detailed profile to the seller. The seller uses identity information in the detailed profile to contact the listing party.

In some embodiments, matching is performed between students and prospective educational institutions.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to physical storage media (or vice versa). For example, computer-executable instructions or data structures received over a network or data link can be buffered in RAM within a network interface module (e.g., a “NIC”), and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Generally embodiments of the invention facilitate matching buyers and sellers of (including but not limited to complex) services and products online, such as, for example, via the Internet or WAN.

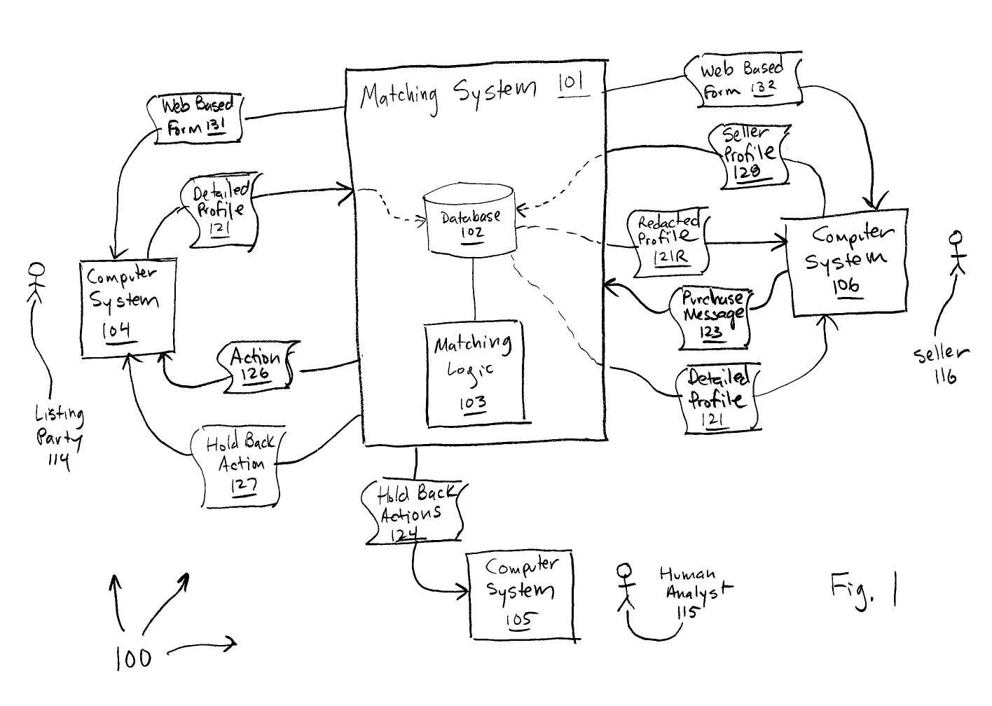

FIG. 1 illustrates an example computer architecture 100 that facilitates anonymous online matching for products and services. Referring to FIG. 1, computer architecture 100 includes matching system 101, computer system 104, computer system 105, and computer system 106. Each of the depicted computer systems can be connected to one another over a network, such as, for example, a Local Area Network (“LAN”), a Wide Area Network (“WAN”), and even the Internet. Accordingly, these connected components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (“SOAP”) etc.) over the network.

Listing party 114 can use computer system 104 to submit detailed profile 121 to matching system 101. Matching system 101 can subsequently store detailed profile 121 in database 102. To receive profile information, matching system 101 can include a Web server that transmits Web based forms to computer systems. Users at the computer systems can fill out the Web based form in entered profile information and return profile information to matching system 101. For example, Web based form 131 can be transmitted to computer system 104. A Web browser at computer system 104 can receive the Web based form and present the Web based form to listing party 114.

Listing party 114 can fill out the Web based form and select user-interface control to send profile information entered into the Web based form back to matching system 101. The entered information can result in a detailed profile, such as for example, detailed profile 121, for goods and/services listing party 114 is interested

Detailed profile 121 can include contact and other personal information of listing party 114. Detailed profile 121 can also describe a desired good and/or service, for example, that listing party 114 desires to rent or purchase. Detailed profile 121 can, for example, indicate contact information for listing party 114 and describe (in as much detail as necessary) an item that prospective buyer 114 desires to purchase.

Within detailed profile 121, or through other interactions with matching system 101, listing party 114 can also indicate the number of actions responsive to detailed profile 121 that they are willing to consider. Specifying the number of proposals enables listing party 114 to ensure that they will not receive an inordinate number responsive actions, one or more of which may be irrelevant to the goods or services described in detailed profile 121. Listing party 114 can adjust the number of actions, increasing or decreasing the number as desired.

A target audience, for example, including seller 116, is permitted to browse redacted profiles of listing parties. For example, using computer systems 106 seller 116 request profiles related to goods and/or services it can provide. Based on this information, matching system 101 can detect some degree of likelihood that seller 116 can provide goods and/or services listed in detailed profile 121. Thus, matching system 101 can retrieve detailed profile 121 for database 102. Matching system 101 can redact specified portions of detailed profile 121 to create redacted profile 121R.

Accordingly, redacted profile 121R contains a subset of the information contained in detailed profile 121. For example, identity information for listing parting 114 can be omitted from redacted profile 121R. As such, redacted profile 121R can include relevant information for making a decision with respect to requested goods and/or services, for example, an offer to buy goods and/or services, without revealing the identity of listing party 114. In some embodiments, redacted profile 121R includes everything from detailed profile 121 except, name, address, phone number, etc., of listing party 114.

Seller 116 as well as other in a target audience can browse redacted profiles stored in database 102. In some embodiments, browsing of redacted profiles is permitted without charge. Cost free browsing of redacted profiles permits a seller to rapidly review likely matching profiles and then concentrate on those for which the seller is well-suited to the goods and/or services desired (e.g., based on substantive product or service descriptions in a profile).

In some embodiments, sellers are able to browse profiles subsets of profiles contained in database 102. For example, seller 116 can enter query or search terms into a Web based searching module of matching system 101 that is interfaced to database 102. The query or search terms can indicate goods and/or services seller 116 can provider. Matching system 101 can return redacted profiles that match the query or search terms within a specified threshold. Thus, for example, a painting contractor that is willing to undertake general contracting of projects that involve significant amounts of painting, can review only profiles for construction requests that involve painting.

Refinement in search functionality can be arranged so that it is managed by the listing party 114 (e.g., prospective buyer), seller 116 (e.g., the prospective seller), or a Web site manager (e.g. an administrator of matching system 101). For example, a listing party 114 may decide that they want a house painted only by painters located nearby. According, matching system 101 (e.g., through a Web based form) permits listing party 114 to edit detailed profile 121 to be available only to those sellers that meet that requirement. Further, as previously described, a painter (e.g., seller 116) may only wish to look at general contracting proposals that involve painting. In response to either buyer or seller input, a Web site manager may decide to limit availability of profiles to sellers that clearly meet the buyer's criteria in order to avoid a situation in which the buyer receives irrelevant and unwelcome solicitations.

Costs can be incurred when the seller decides to purchase full contact information for a buyer, for example, based on information revealed in the redacted profile indicating a likely match. For example, upon reviewing redacted profile 121R, seller 116 can determine that it can likely provide goods and/or services indicated in redacted profile 121R. As such, seller 116 can utilize computer system 106 to purchase detailed profile 121. For example, seller 116 can send purchase message 123 to matching system 101 to invoke an electronic transaction to purchase detailed profile 121.

Upon purchase of detailed profile 121, matching system 101 can inform listing party 114. For example, matching system 101 can send action 126 to computer system 104 for presentation to listing party 114. Action 126 can indicate information about seller 116, including identity and a description of goods and/or services that seller 116 can provide. Alternately, action 126 is sent after further review of detailed profile 121. For example, seller 116 can expressly indicate to matching system 101 a desire to contact listing party 114.

Triage of listings by seller 116 has beneficial results for the listing party 114 as well. If listing party 114 is contacted by seller 116, listing party 114 knows that seller 116 had to expend financial resources to obtain their contact information. Thus, listing party 114 can with some degree of confidence be assured that seller 116 is legitimately interested (and likely well suited to serve) in providing goods and/or services listed in detailed profile 121. Thus, listing parties can more likely avoid the wasted time and transaction cost of dealing with potentially irrelevant offerings.

In some embodiments, seller 116 can use computer system 106 to submit seller profile 128 to matching system 101. Matching system 101 can subsequently store seller profile 128 in database 102. To receive seller profile information, matching system 101 can transmits a Web based forms to computer system 106. For example, Web based form 132 can be transmitted to computer system 106. A Web browser at computer system 106 can receive the Web based form and present the Web based form to seller 116. Seller 116 can fill out the Web based form 132 and select user-interface control to send seller profile information entered into the Web based form back to matching system 101. The entered information can result in a seller profile, such as for example, seller profile 128, for goods and/services seller 116 cab provider.

Matching logic 103 can be configured to match a detailed profile to entered search or query terms. For example, matching logic an match detailed profile 121 to search or query terms entered by seller 116. Matching logic 103 can also be configured to match detailed profiles to seller profiles. For example, matching logic 103 can match detailed profile 121 to seller profile 128. In either case, when a match is identified, redacted profile 121R can be transmitted to computer system 106 and action 126 subsequently transmitted to computer system 104. Accordingly, embodiments of the invention include automated matching that facilitates more efficient transactions between a potential buyer and a potential seller.

Further, in some embodiments, a percentage of the permitted contacts may be reserved by a Web site manager. Although the reach of an Internet system is relatively large, it cannot include all plausible sellers. Reserved contacts can be analyzed by a human analyst and can then be offered to the best matching provider of goods and/or services, either with or without a charge. In computer architecture 100, matching system 101 can hold back some number of the specified number of actions for detailed profile 121. For example, matching system 101 can hold back two out of the ten specified actions for detailed profile 121.

Matching system 101 can indicate a number of actions that are reserved or “held back” for presentation to a human analyst. For example, matching system 101 can send holdback actions 124, such as, for example, two out of ten actions for detailed profile 121, to computer system 105. Human analyst 115 can analyze detailed action 121 and attempt to find matches using mechanisms that supplement matching logic 103, such as, for example, friends, known business associates, other referral networks, etc.

Human analyst 115 can also utilize matching logic 103 in a more interactive matter including having full access to all detailed profiles stored in database 102 to attempt to identify matches. Further, human analyst 115 can have a higher degree of technical skill in searching and may simply be better at identifying matches since they have been trained and/or have experience in perfuming such searches. In any event, human analyst 115 may be able to identity matches that matching logic 103, sellers, buyers, etc., did not identify.

When human analyst 115 identifies a match, it can be sent to a listing party as an action. For example, matching stem 101 can send hold back action 127 to listing party 114. An action's designation as a hold back action can indicate to a listing party that the action was identified by a human analyst. For example, hold back action 127 can indicate to listing party 114 that it was identified by human analyst 115.

When a hold back action is acting on by a listing party the human analyst can receive compensation. For example, when listing party 114 acts on hold back action 127 (e.g., makes a purchase, contacts a seller, etc.), human analyst 115 can be compensated financially.

Reserving or “holding back” contacts decreases transaction costs on both sides. A buyer obtains search and information services without paying. A seller obtains the same services. A seller may be charged, but will not have incurred the transaction expenses of searching a database.

When a seller is not charged, the transaction costs are still minimized on both sides. In addition to search and information services, reserved contacts may provide the benefits of expertise to both buyer and seller. In a specialized area, a human analyst may be able to discern a match between buyer's requirements and seller's abilities better than the buyer, the seller, or matching logic 103. Accordingly, embodiments can return automatically selected and/or manually selected sellers to a prospective buyer.

When an action is returned to computer system 104, whether manually or automatically selected, matching system 101 can update detailed profile 121. For example, matching system 101 can update detailed profile 121 to include (a) the number of contacts the buyer has indicated he is willing to review; (b) the date the profile was created; (c) the number of times the profiles identifying information has been purchased; (d) the dates of those purchases; and (e) the identity of prior purchasers. Updating a detailed profile in this manner also permits a seller to assess the current state of competition for a buyer. For example, this type of updated information can be included in a redacted profile sent to a potentially seller. The potential seller can user this type of profile information to determine whether an investment in responding to the redacted profile is likely to result in a transaction.

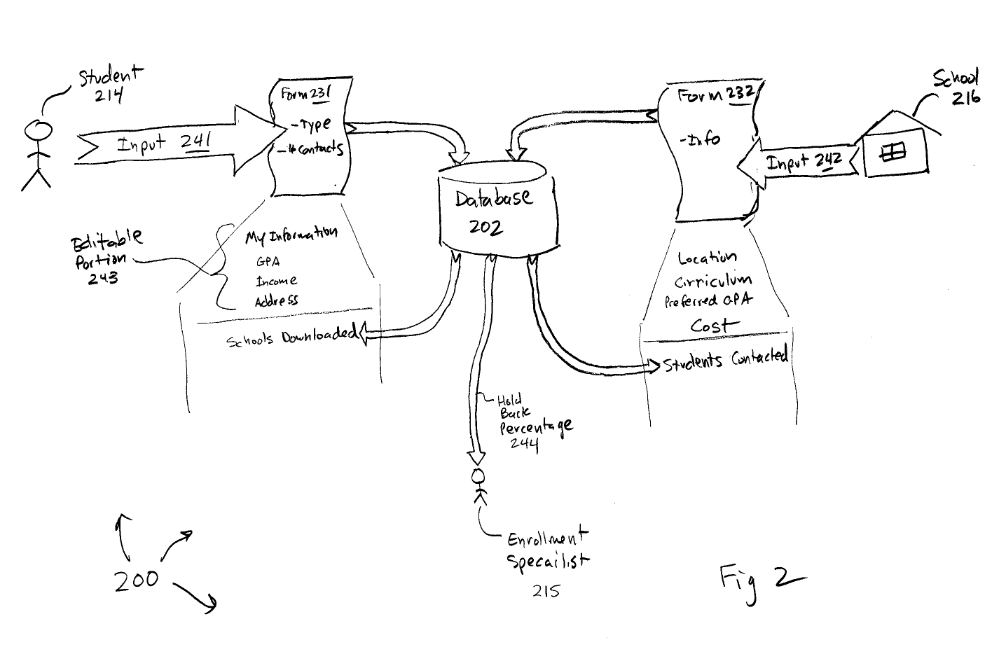

In some embodiments, a matching system is used to match students and secondary education institutions. FIG. 2 illustrates a computer architecture 200 that facilitates anonymous online matching between students and prospective education institutions. Similarly to computer architecture 100, the depicted components of computer systems 200 can be connected to one another over a network, such as, for example, a Local Area Network (“LAN”), a Wide Area Network (“WAN”), and even the Internet. Accordingly, these connected components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), Simple Object Access Protocol (“SOAP”) etc.) over the network.

Further, computer architecture 200 depicts various data flows. It should be understood that the data flows can be between computer systems that are used by or contained within the expressly depicted elements in computer architecture 200. For example, student 214 can use a computer system to enter input 241 into form 231. Likewise a representative of school 216 can user a computer system to enter input 242 into form 232. Similarly, database 202 can be contained within a computer system. Further, enrollment specialist 215 can use a computer system to identify matches for “hold back” actions.

As depicted in computer architecture 200, student 214 enters input 241 (e.g., using computer input devices) into form 231 (e.g., a Web based form). Form 231 can include various fields for entering personal information as well as description a desired educational institution. For example, form 231 can include fields for indicating an institution type, such as, for example, vocation schools, two-year colleges, four-year colleges, graduate schools, or professional schools. Form 231 can also include a field for the number of contacts student 214 desires to receive. Form 231 can also include fields for receiving student information, such as, for example, high school GPA, any income, need for financial assistance, address, telephone number, etc. Input 241 can include some or all of this information. Upon completion, student 214 can submit form 231 (e.g., via computer network transmission) to database 202.

Thus, prospective students create a detailed profile detailing their ideal school, educational experience, and achievement record, financial and demographic information. A redacted version of the detailed profile is made generally available to secondary education institutions. Built to protect the privacy of students who use the system, the system permits students to determine the number of secondary education institutions (and potentially also student loan providers) they are willing to have contact them (“allowed actions”). A default suggested number allowed actions, such as, for example, 15, can be imposed. However, students are permitted to adjust the number of allowed actions up or down as they see fit. Students may also remove their profile from the system at anytime.

Similarly, school 216 can enter input 242 into form 232 (e.g., a Web based form). Form 232 can include various fields for entering institutional information. For example, form 231 can include fields for location, curriculums, preferred GPA range, cost, scholarship opportunities, athletics programs, etc. Input 242 can include some or all of this information. Upon completion, school 216 can submit form 232 (e.g., via computer network transmission) to database 202.

Matching logic can attempt to automatically match students with schools based on profiles in database 202. Likewise, schools can search redacted profiles (potentially at no cost) by entering search or query terms to database 202.

Schools can be permitted to search redacted student profiles at no cost. Redacted profiles in database 202 do not contain any information from which the identity of a student can be ascertained. When a school finds a student that matches well with their school's offerings, they can purchase and download the student's full profile (containing all the information student has entered). For example, if student 214 matches within the information for school 216, school 216 can download all of information entered into form 23 1. Form 232 can be updated to indicate that student 214 was contacted.

Accordingly, schools can search and view redacted prospective student profiles containing non-personal information. The schools can then use the non-personal information as the basis for a decision to purchase or not purchase a complete student profile. Accordingly, the matching system allows colleges to decide which students are a sufficient match for them, prior to paying for the student's full contact information and any other detailed profile information.

Further, a matching system can hold back some percentage, such as, for example, approximately 10-20%, of actions allowed by students in order to promote the effectiveness of the system for students (as well as colleges). These “holdback actions” can be forwarded to human enrollment advisors. The human enrollment advisors can then match students and secondary education institutions based on school and student profile information, likely producing a better match. For example, enrollment specialist 215 can be given hold back percentage 244 of actions from database 202.

Working in a similar manner to how the matching system works for schools, student loan providers can search the database at no charge for students who have indicated that they need a student loan and would like to be contacted by a lender.

When a student receives can action, the schools information can be downloaded into the student's profile. For example, if school 216 purchases a detailed profile for student 214, information for school 216 can be downloaded into the students profile for viewing.

Downloaded school information may not be editable. Thus, a detailed student profile can include an editable portion, such as, for example, editable portion 243 and a non-editable portion.

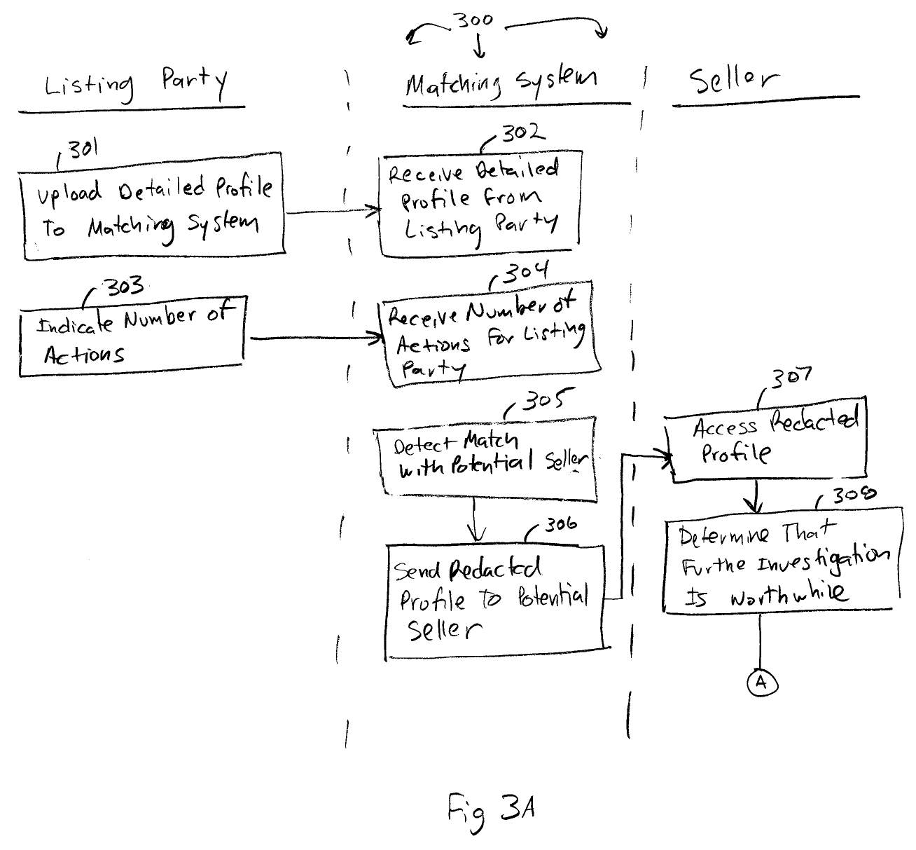

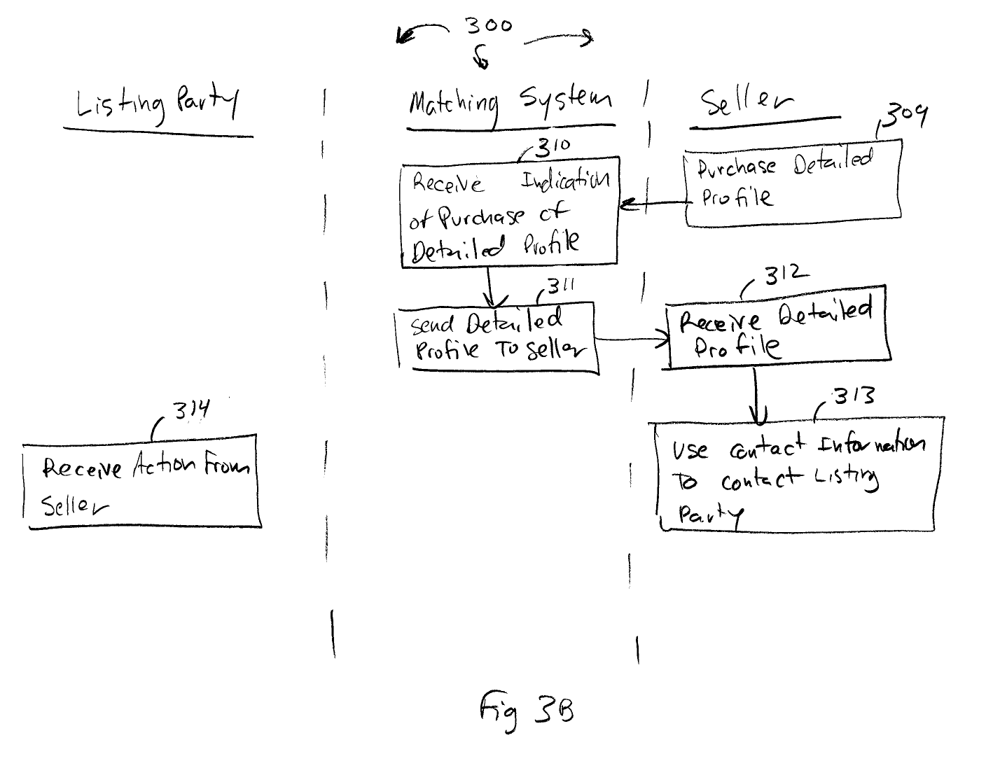

FIGS. 3A and 3B illustrate a flow chart of an example method for anonymous online matching for products and services. Method 300 will be described with respect to the components and data in computer architectures 100.

Method 300 includes an act of uploading a detailed profile to a matching system (act 301). For example, computer system 104 can upload detailed profile 121 (for listing party 114) to matching system 101. Method 300 includes an act of receiving a detailed profile from a listing party (act 302). For example, matching system 1010 can receive detailed profile 121 and stored detailed profile 121 in database 102.

Method 300 includes an act of indicating the number of actions the listing party is willing to receive (act 303). For example, computer system 104 can indicate the number of actions listing party 114 is willing to receive for detailed profile 121. The indication can be transmitted within or separate from detailed profile 121. Method 300 includes an act of receiving number of actions for the listing party (act 304). For example, matching system 101 can receive the indication of the number of actions listing party 114 is willing to receive for detailed profile 121.

Method 300 includes an act of detecting a matching with a potential seller (act 305). For example, matching system 101 using automated (e.g., matching logic 103) and/or human mechanisms (e.g., human analyst 115) can detect that seller 116 is potentially a match for listing party 114. In response to a match, seller 116 can request a profile for listing party 114.

Method 300 includes an act of sending a redacted profile to the potential seller (act 306). For example, matching system 101 can send redacted profile 121R to computer system 106 (the computer system for seller 116). Method 300 includes an act of accessing a redacted profile (act 307). For example, computer system 106 can receive redacted profile from matching system 101.

Method 300 includes an act of determining that further investigation is worthwhile based on the content of the redacted profile (act 308). For example, based on the content of redacted profile 121R, seller 116 can determine that further o m investigation of providing the goods and/or services described in redacted profile 121R is worthwhile.

Method 300 includes an act of purchasing the detailed profile (act 309). For example, seller 116 can use computer system 106 to purchase detailed profile 121 from (e.g., to send purchase message 123 to) matching system 101. Method 300 includes an act of receiving an indication of purchase of the detailed profile (act 310). For example, matching system 101 can receive the purchase of detailed profile 121 (e.g., purchase message 123) from computer system 106.

Method 300 includes an act of sending the detailed profile to the potential seller (act 311). For example, matching system 101 can send detailed profile 121 to compute system 106. Method 300 includes an act of receiving the detailed profile (act 312). For example, computer system 106 can received detailed profile 121 form matching system 101.

Method 300 includes an act of using contact information in the detailed profile to contact the listing party (act 313). For example, seller 116 can use information in detailed profile 121 to contact listing party 114. Method 300 includes an act of receiving an action from the seller (act 314). For example, matching system 101 can update detailed profile 101 to indicate that seller 116 purchased detailed profile 101.

Method 300 or other similar methods can also be used to match a student with an educational institution.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. At a computer system used by a prospective buyer of a good or service, a method for matching the prospective buyer to a seller that is selling an good or service that potentially matches, the method comprising:
uploading a detailed profile to a matching system;
indicating a number of actions the prospective buy is willing to receive with respect to the good or service; and
receiving at least one action from a seller that is proposing a sale of a potentially matching good or service.

2. The method as recited in claim 1, wherein uploading the detailed profile comprises uploading a detailed profile including data indicating various preferences of the prospective buyer with respect to a good or service the prospective buy desires to purchase.

3. The method as recited in claim 1, wherein uploading the detailed profile comprises uploading a detailed student profile including data indicating a student's desires and qualifications for attending an educational institution

4. The method as recited in claim 1, wherein uploading a detailed profile to a matching system comprises uploading a detailed profile to a matching system, the detailed profile including a portion of information that is to be redacted for presentation to a potential seller.

5. The method as recited in claim 1, wherein receiving at least one action from a seller that is proposing a sale of a potentially matching good or service comprises an act of receiving a hold back action that was identified by a human analyst.

6. At a computer system used by a seller of a good or service, a method for matching a prospective buyer to a good or service for sale by the seller, the prospective buyer desires to purchase, the method comprising:
accessing a redacted profile from a matching system, the redacted profile indicating basic information related to good or service a listing party is interested in;
determining, based on information in the redacted profile, that further investigation of the listing party is worthwhile;
purchasing a detailed profile for the listing party from the matching system; and
using contact information in the detailed profile to contact the prospective buyer and make them aware of the good or service for sale by the seller.

7. The method as recited in claim 6, wherein accessing a redacted profile comprises accessing preferences of a prospective buyer with respect to a good or service the prospective buy desires to purchase

8. The method as recited in claim 6, wherein accessing a redacted profile comprises accessing preferences of a prospective student with respect desires and qualifications for attending an educational institution.

9. The method as recited in claim 6, wherein determining, based on information in the redacted profile, that further investigation of the listing party is worthwhile comprises an act of determining the further investigation of a potential buyer is worthwhile, based on the ability of the seller to provider a request good or service.

10. The method as recited in claim 6, wherein determining, based on information in the redacted profile, that further investigation of the listing party is worthwhile comprises an act of determining the further investigation of a potential student is worthwhile, based on the students desires in and qualifications for attending an educational institution.

11. The method as recited in claim 6, wherein purchasing a detailed profile for the listing party from the matching system comprises an act of purchasing a detailed profile for a potential buyer of a good or service.

12. The method as recited in claim 6, wherein purchasing a detailed profile for the listing party from the matching system comprises an act of an educational institution purchasing a detailed profile for a student.

13. At a matching system for matching prospective buyers and sellers, a method for responding to buyers request for a good or server, the method comprising:
receiving a detailed profile from a listing party;
receiving an indicating a number of actions the listing party is willing to receive with respect to a good or service;
holding back a portion of the number of actions for manually processing by staff of the matching system; and
returning an action from the matching system to the listing party.

14. The method as recited in claim 13, wherein the act of receiving a detailed profile from a listing party comprises an act of receiving a detailed profile from a prospective buyer, the detailed profile including data indicating various preferences of the prospective buyer with respect to a good or service the prospective buy desires to purchase.

15. The method as recited in claim 14, further comprising:
an act of detecting a match between the potential buyer and a potential seller based on information in the detailed profile.

16. The method as recited in claim 13, wherein the act of receiving a detailed profile from a listing party comprises an act of receiving a detailed student profile including data indicating a student's desires and qualifications for attending an educational institution.

17. The method as recited in claim 16, further comprising:
an act of detecting a match between the student and an educational institution based on information in the detailed profile.

18. The method as recited in claim 13, wherein the act of receiving a detailed profile from a listing party comprises an act of receiving a detailed profile, the detailed profile including a portion of information that is to be redacted for presentation to a potential seller.

19. The method as recited in claim 13, further comprising:
an act of receiving an indication that a human analyst found a match for the detailed profile.

20. The method as recited in claim 19, wherein the act of returning an action from the matching system to the listing party comprises an act of returning a hold back action to the listing party
